(19) United States
(12) Patent Application Publication
(10) Pub. No.: US 2026/0110926 A1
(43) Pub. Date: Apr. 23, 2026

(54) TUNABLE LIGHT SOURCES FOR A PHOTONIC CHIP

(71) Applicant: GlobalFoundries U.S. Inc., Malta, NY (US)

(72) Inventors: Spencer Ferguson, Clifton Park, NY (US); Yusheng Bian, Ballston Lake, NY (US)

(21) Appl. No.: 18/907,712

(22) Filed: Oct. 7, 2024

(51) Int. Cl. G02F 1/03; G02B 6/132

(52) U.S. Cl. CPC G02F 1/0311; G02B 6/132; G02F 2201/066; G02F 2201/302; G02F 2202/16

(57) ABSTRACT

Structures for a photonic chip that include a grating and a light source, as well as methods of forming such structures. The structure comprises a grating that includes segments. The grating comprises a material having a refractive index that is variable in response to a stimulus, such as an applied bias voltage. The structure further comprises a waveguide core that includes a section adjacent to the segments of the grating. The structure may further include a light source adjacent to the grating.

### BACKGROUND

This disclosure relates to photonic chips and, more specifically, to structures for a photonic chip that include a grating and a light source, as well as methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as a semiconductor laser or semiconductor optical amplifiers. Conventional semiconductor lasers and semiconductor optical amplifiers lack a satisfactory mechanism for tuning the spectrum of the light that is emitted.

Improved structures for a photonic chip that include a grating and a light source, as well as methods of forming such structures are needed.

### SUMMARY

In an embodiment of the invention, a structure for a photonic chip is provided. The structure comprises a grating that includes segments. The grating comprises a material having a refractive index that is variable in response to a stimulus, such as an applied bias voltage. The structure further comprises a waveguide core that includes a section adjacent to the segments of the grating. The structure may further include a light source adjacent to the grating.

In an embodiment of the invention, a method of forming a structure for a photonic chip is provided. The method comprises forming a grating that includes segments. The grating comprises a material having a refractive index that is variable in response to a stimulus, such as an applied bias voltage. The method further comprises forming a waveguide core that includes a section adjacent to the plurality of segments of the grating. The method may further comprise positioning a light source adjacent to the grating.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a top view of the structure at a fabrication stage of the processing method subsequent to FIGS. 1, 1A.

FIG. 2A is a cross-sectional view taken generally along line 2A-2A in FIG. 2.

FIG. 2B is a cross-sectional view taken generally along line 2B-2B in FIG. 2.

FIG. 3 is a top view of the structure at a fabrication stage of the processing method subsequent to FIGS. 2, 2A, 2B.

FIG. 3A is a cross-sectional view taken generally along line 3A-3A in FIG. 3.

FIG. 3B is a cross-sectional view taken generally along line 3B-3B in FIG. 3.

FIG. 4 is a top view of a structure in accordance with embodiments of the invention.

FIG. 4A is a cross-sectional view taken generally along line 4A-4A in FIG. 4.

FIG. 5 is a cross-sectional view of a structure in accordance with embodiments of the invention.

FIG. 6 is a top view of a structure in accordance with embodiments of the invention.

FIG. 7 is a cross-sectional view of a structure in accordance with embodiments of the invention.

### DETAILED DESCRIPTION

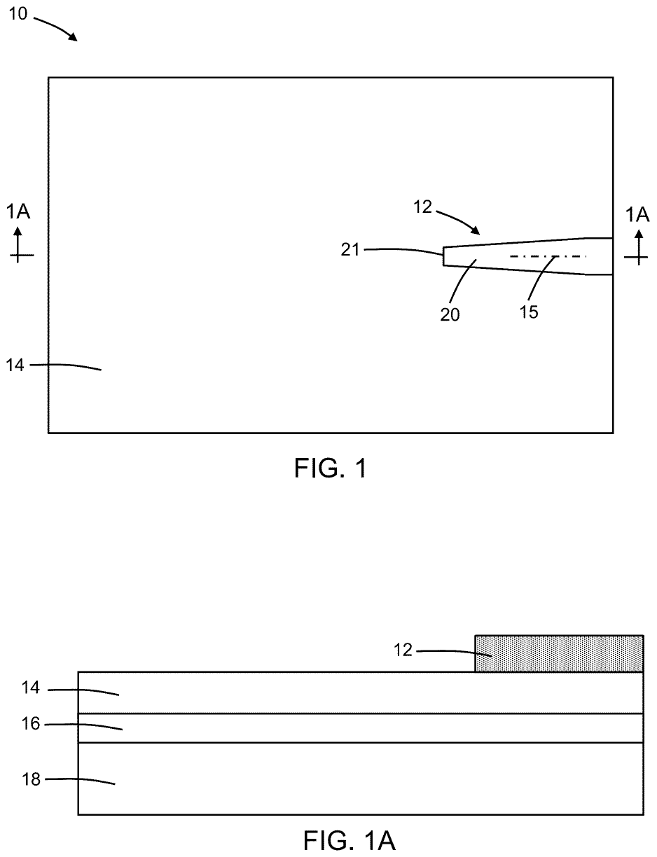

With reference to FIGS. 1, 1A and in accordance with embodiments of the invention, a structure 10 for a photonic chip includes a waveguide core 12 that may be positioned on, and above, a dielectric layer 14, a dielectric layer 16, and a semiconductor substrate 18. In an embodiment, the dielectric layers 14, 16 may be comprised of a dielectric material, such as silicon dioxide, and the semiconductor substrate 18 may be comprised of a semiconductor material, such as single-crystal silicon. In an embodiment, the dielectric layer 16 may be a buried oxide layer of a silicon-on-insulator substrate. The dielectric layers 14, 16 may provide low-index cladding that separates the waveguide core 12 from the semiconductor substrate 18. In an alternative embodiment, the dielectric layer 14 may be omitted.

The waveguide core 12 may include a tapered section 20 that terminates at an end surface 21 and that is aligned along a longitudinal axis 15. The tapered section 20 may have a width dimension increases linearly with increasing distance from the end surface 21. In an alternative embodiment, the width dimension of the tapered section 20 may vary based on a non-linear function, such as a quadratic function, a cubic function, a parabolic function, a sine function, a cosine function, a Bezier function, or an exponential function. In an embodiment, the tapered section 20 may include a single stage of tapering characterized by a taper angle. In an alternative embodiment, the tapered section 20 may taper in multiple stages each characterized by a different taper angle. The waveguide core 12 may be connected to a photonic integrated circuit and light from a light source may propagate in the waveguide core 12 from the tapered section 20 to the photonic integrated circuit.

In an embodiment, the waveguide core 12 may be comprised of a material having a refractive index that is greater than the refractive index of silicon dioxide. In an embodiment, the waveguide core 12 may be comprised of a dielectric material, such as silicon nitride, silicon oxynitride, or aluminum nitride. In an alternative embodiment, the waveguide core 12 may be comprised of a semiconductor material, such as silicon. In alternative embodiments, other materials, such as a polymer, diamond, thin-film lithium niobate, boron nitride, barium titanate, or a III-V compound semiconductor material, may be used to form the waveguide core 12. The waveguide core 12 may be formed by patterning a layer comprised of its constituent material with lithography and etching processes. In an embodiment, the waveguide core 12 may be formed by patterning the semiconductor material, which may be single-crystal silicon, of the device layer of a silicon-on-insulator substrate.

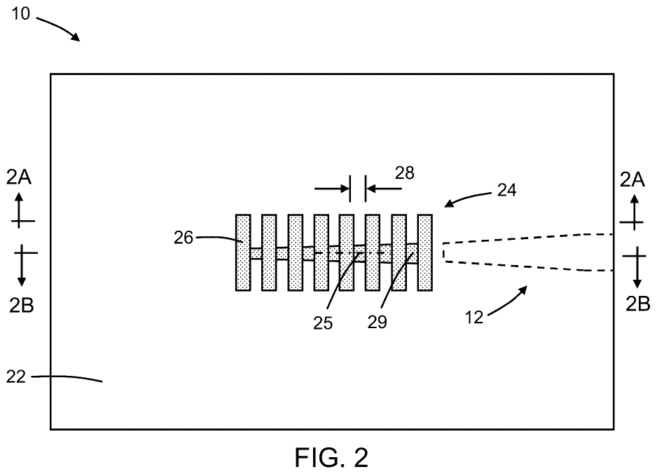

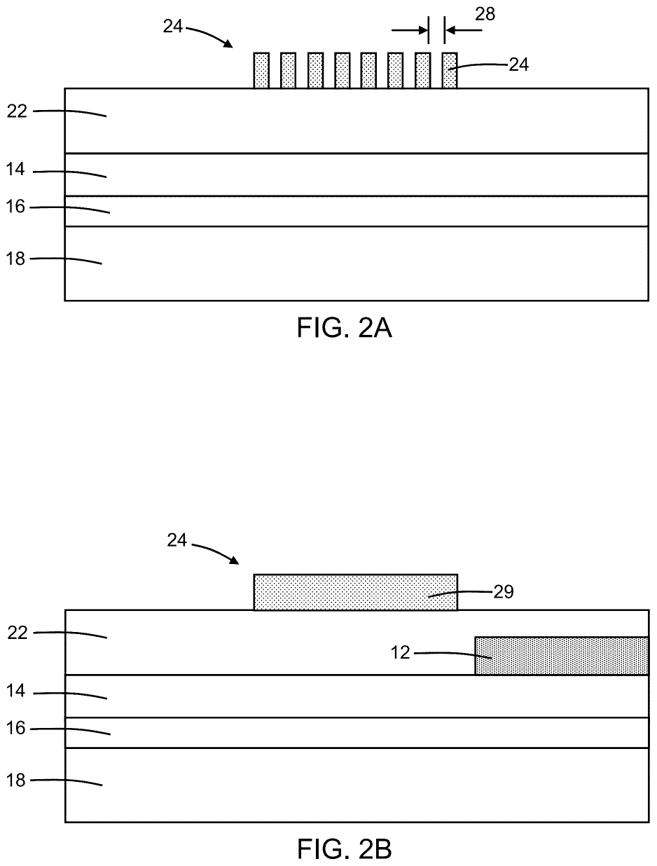

With reference to FIGS. 2, 2A, 2B and at a fabrication stage subsequent to FIGS. 1, 1A, a dielectric layer 22 may be formed over the waveguide core 12. The dielectric layer 22 may be comprised of a dielectric material, such as silicon dioxide, deposited by chemical vapor deposition and planarized with, for example, chemical-mechanical polishing to remove topography. The dielectric layer 22 may provide low-index cladding for the waveguide core 12.

A grating 24 may be formed on, and over, the dielectric layer 22. The grating 24, which is disposed at a different elevation in the structure 10 than the waveguide core 12, may be positioned laterally adjacent to the waveguide core 12. The grating 24 may include multiple grating structures or segments 26 that are laterally spaced on the dielectric layer 22 with a given pitch along a longitudinal axis 25. In an embodiment, the longitudinal axis 25 may be aligned parallel to the longitudinal axis 15 (FIG. 1) of the waveguide core 12. In an embodiment, the segments 26 may be rectangular ridges or strips with a length dimension transverse to the longitudinal axis 25 and a width dimension that is less than the length dimension. In an embodiment, the segments 26 may be disposed in direct contact with the dielectric layer 22 and may project upwardly away from the top surface of the dielectric layer 22.

The segments 26 of the grating coupler 12 have an alternating arrangement with grooves 28 that separate adjacent pairs of segments 26. In an embodiment, the segments 26 and grooves 28 may have a uniform width and a uniform duty cycle to define a periodic arrangement. In an alternative embodiment, the segments 26 and grooves 28 may have a non-uniform width and/or a non-uniform duty cycle to define an aperiodic structure. In an alternative embodiment, the segments 26 may be curved ridges instead of linear ridges as shown in the representative embodiment.

The segments 26 may be comprised of an active material characterized by a variable refractive index that can be tuned by an applied stimulus to transition between multiple states that are characterized by different refractive indices. In an embodiment, the variable refractive index of the active material may be tuned by an applied stimulus in the form of an applied bias voltage to provide the multiple states characterized by different refractive indices. In alternative embodiments, the tuning can be produced by applying and removing a different type of applied stimulus than an applied bias voltage, such as heating or optical absorption by optical pumping.

The segments 26 may be formed from a layer that is deposited by, for example, atomic layer deposition or chemical vapor deposition and then patterned with lithography and etching processes. In an embodiment, the segments 26 may be comprised of a conducting oxide, such as indium-tin oxide. In an alternative embodiment, the segments 26 may be comprised of a phase change material, such as vanadium oxide or germanium-antimony telluride. In an alternative embodiment, the segments 26 may be comprised of a two-dimensional material, such as graphene or molybdenum disulphide.

In an embodiment, a ridge 29 may be overlaid with the segments 26. The ridge 29 may have a width that is narrower than the length of the shortest of the segments 26. In an embodiment, the ridge 29 may provide a spine that connects all of the segments 26 together. In an embodiment, the ridge 29 may provide a spine that connects fewer than all of the segments 26 together. In an alternative embodiment, the grating 24 may include a slab layer that is thinner than the segments 26 and the ridge 29 and that is connected to lower portions of the segments 26 and the ridge 29.

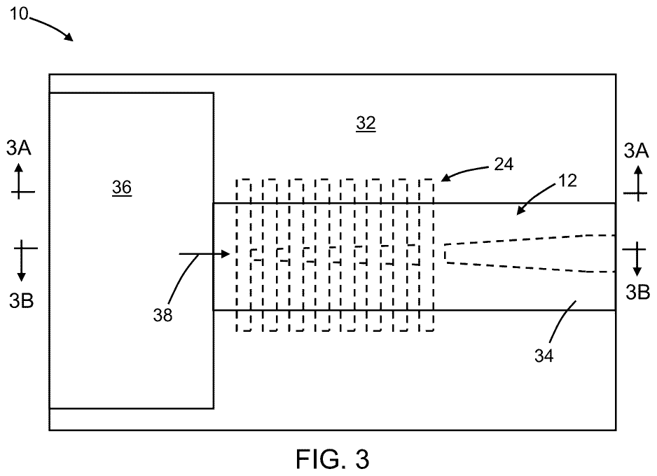

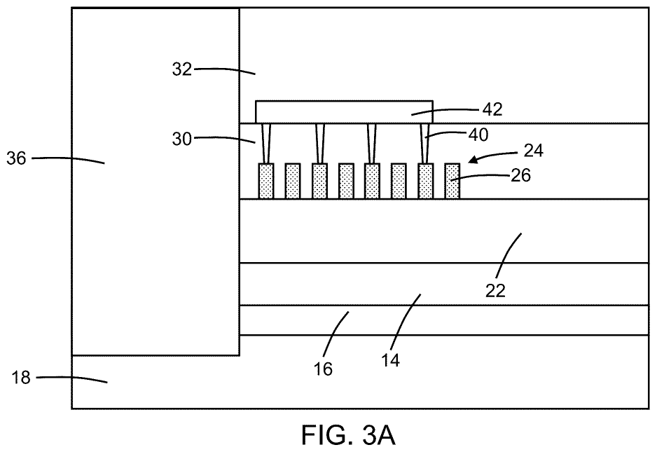

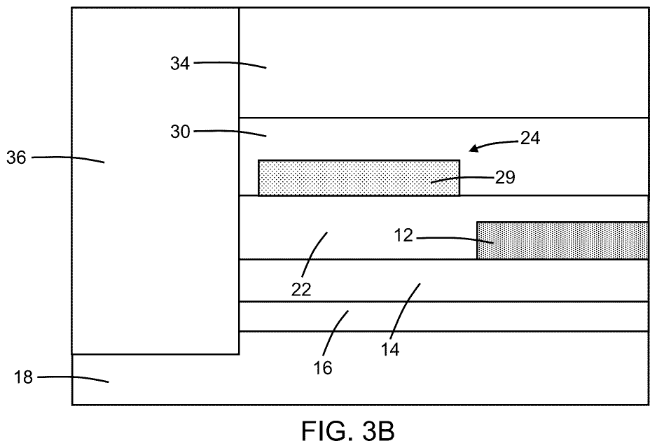

With reference to FIGS. 3, 3A, 3B in which like reference numerals refer to like features in FIGS. 2, 2A, 2B and at a subsequent fabrication stage, a dielectric layer 30 may be formed over the dielectric layer 22 and the grating 24. The dielectric layer 30 may be comprised of a dielectric material, such as silicon dioxide, deposited by chemical vapor deposition and planarized with, for example, chemical-mechanical polishing to remove topography. The segments 26 are embedded or buried in the dielectric material of the dielectric layer 30 such that the grooves 28 are filled by the dielectric material of the dielectric layer 30.

A back-end-of-line stack 32 may be formed over the dielectric layer 30. The back-end-of-line stack 32 may include the heterogenous dielectric layers of multiple metallization levels that are arranged in a layer stack over the dielectric layer 30. The dielectric layers of the back-end-of-line stack 32 may be comprised of dielectric materials, such as silicon dioxide, silicon nitride, tetraethylorthosilicate silicon dioxide, and/or fluorinated-tetraethylorthosilicate silicon dioxide.

A dielectric layer 34 that may be formed that replaces a removed portion of the back-end-of-line stack 32 directly over the waveguide core 12 and the grating 24. The dielectric layer 34 may be comprised of a homogenous dielectric material, such as silicon dioxide.

A light source 36 may be placed adjacent to the grating 24. In an embodiment, the light source 36 may be positioned in a cavity that extends into the semiconductor substrate 18. The light source 36 may include a light output 38 that is aligned with the grating 24 and that is configured to provide light in a mode propagation direction toward the grating 24. In an embodiment, the light source 36 may be a broadband light source. In an embodiment, the light source 36 may be a laser chip that includes a semiconductor laser configured to generate broadband light in an infrared wavelength range. In an embodiment, the laser chip may include a gain medium comprised of III-V compound semiconductor materials. In an embodiment, the laser chip may include a multi-quantum well comprised of III-V compound semiconductor materials that is configured to generate broadband laser light in an infrared wavelength range. In an embodiment, the light source 36 may be a semiconductor optical amplifier. In an embodiment, the light source 36 may be a Fabry-Perot laser diode.

Contacts 40 are formed that electrically and physically couple the grating 24 to one or more metal features 42 in the back-end-of-line stack 32. In an alternative embodiment, the contacts 40 may be electrically and physically coupled to one, or both, of the opposite ends of some or all of the segments 26. In an alternative embodiment, the contacts 40 may be electrically and physically coupled to a thin slab layer added to the grating 24 instead of being coupled to the segments 26.

The refractive index of the active material of the grating 24 can be altered to tune the characteristics of light, such as the light spectrum and peak wavelength, that is transferred from the light source 36 to the tapered section 20 of the waveguide core 12. The tuning can be produced by applying a stimulus, such as an applied bias voltage, capable of adjusting the refractive index of the active material of the grating 24. In an embodiment, a bias voltage may be applied from a power supply through the contacts 40 and the one or more metal features 42 to selectively adjust the refractive index of the active material of the grating 24 between the different refractive index states and thereby tune the light spectrum and peak wavelength of the light source 36 that is being transferred by the grating 24 to the tapered section 20 of the waveguide core 12 and the photonic integrated circuit connected to the waveguide core 12.

The light spectrum and peak wavelength of the light source 36 can be tuned by an applied stimulus between different conditions characterized by different values of the refractive index of the active material of the grating 24. In particular, the variable refractive index of the active material of the grating 24 may be leveraged to shift and select the light spectrum and peak wavelength of the light output by the light source 36. Variation of the refractive index of the active material of the grating 24 may enable tuning of the light spectrum and peak wavelength of the light source 36 over a wide wavelength range. Due to the presence of the grating 24, the light source 36 does not require an internal mechanism to provide tuning.

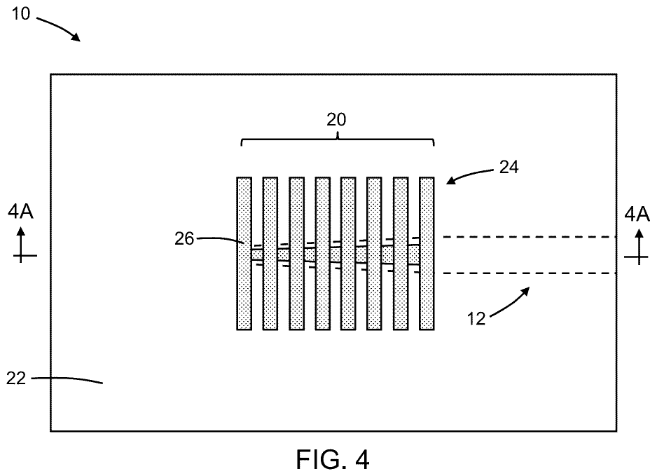

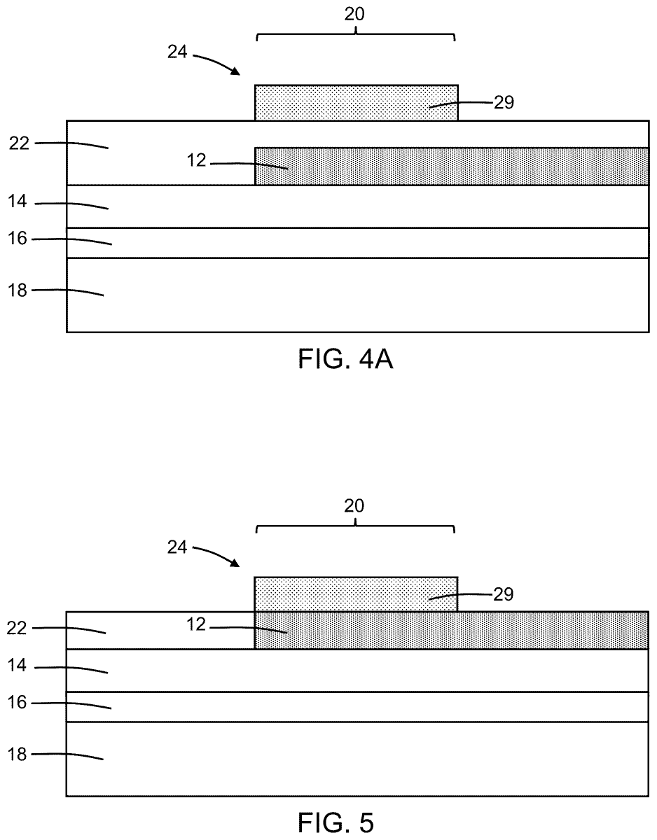

With reference to FIGS. 4, 4A and in accordance with alternative embodiments, the location of the tapered section 20 of the waveguide core 12 may be shifted such that the grating 24 overlaps with the tapered section 20. In an embodiment, the segments 26 and ridge 29 of the grating 24 may fully overlap with the tapered section 20 of the waveguide core 12. In an alternative embodiment, the segments 26 and ridge 29 of the grating 24 may overlap with a portion of the tapered section 20 of the waveguide core 12. In an embodiment, the terminating end surface 21 of the tapered section 20 may be aligned, and overlap, with the segment 26 of the grating 24 closest to the light source 50 (FIG. 3).

With reference to FIG. 5 and in accordance with alternative embodiments, the grating 24 may be positioned on the tapered section 20 of the waveguide core 12 and portions of the dielectric layer 22 adjacent to the tapered section 20. In an embodiment, the grating 24 may be positioned in direct contact with the tapered section 20 of the waveguide core 12 and portions of the dielectric layer 22 adjacent to the tapered section 20.

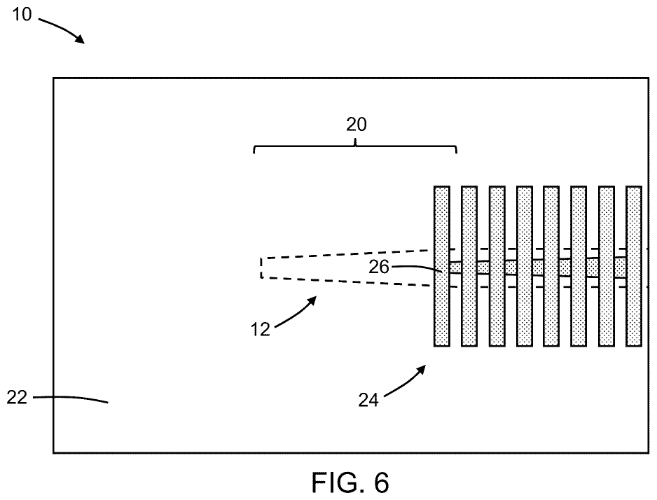

With reference to FIG. 6 and in accordance with alternative embodiments, the location of the tapered section 20 of the waveguide core 12 may be shifted such that at least a portion of the tapered section 20 of the waveguide core 12 is closer to the light source 36 (FIG. 3) than the grating 24. In an embodiment, the tapered section 20 may be disposed fully between the light source 36 and the grating 24. In an embodiment, the segments 26 and ridge 29 of the grating 24 may have a non-overlapping relationship with the tapered section 20 of the waveguide core 12. In an embodiment, the grating 24 may provide a distributed Bragg reflector that reflects light.

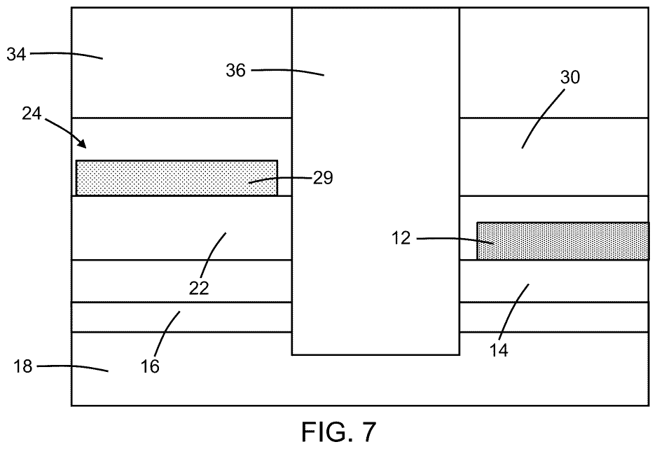

With reference to FIG. 7 and in accordance with alternative embodiments, the grating 24 may be positioned on an opposite side of the light source 36 from the waveguide core 12 and, in particular, on an opposite side of the light source 36 from the tapered section 20 of the waveguide core 12. As a result, the light source 36 is positioned between the tapered section 20 of the waveguide core 12 and the grating 24. In an alternative embodiment, another grating like the grating 24 may be positioned between the light source 36 and the tapered section 20 of the waveguide core 12.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a photonic chip, the structure comprising:
a grating including a plurality of segments, the grating comprising a first material having a refractive index that is variable in response to a stimulus; and
a waveguide core including a section adjacent to the plurality of segments of the grating.

2. The structure of claim 1 further comprising:
a light source adjacent to the grating.

3. The structure of claim 2 wherein the section of the waveguide core is positioned between the grating and the light source.

4. The structure of claim 2 wherein the grating is positioned between the section of the waveguide core and the light source.

5. The structure of claim 2 wherein the light source is configured to output light, and the grating is configured to couple the light to the section of the waveguide core.

6. The structure of claim 5 wherein the grating is configured to shift a spectrum of the light output by the light source and coupled by the grating to the section of the waveguide core.

7. The structure of claim 1 further comprising:
a light source positioned between the waveguide core and the grating.

8. The structure of claim 1 wherein the grating overlaps with a portion of the section of the waveguide core.

9. The structure of claim 1 wherein the grating fully overlaps with the section of the waveguide core.

10. The structure of claim 1 wherein the grating has a non-overlapping relationship with the section of the waveguide core.

11. The structure of claim 1 wherein the grating includes a ridge that is overlaid on the plurality of segments, and the ridge comprises the first material.

12. The structure of claim 1 further comprising:
a dielectric layer between the grating and the section of the waveguide core.

13. The structure of claim 1 wherein the first material comprises a conducting oxide.

14. The structure of claim 1 wherein the first material comprises a phase change material.

15. The structure of claim 1 wherein the first material comprises a two-dimensional material.

16. The structure of claim 1 wherein the waveguide core comprises a second material, and the second material is different from the first material.

17. The structure of claim 1 further comprising:
a silicon-on-insulator substrate including a semiconductor substrate and a dielectric layer on the semiconductor substrate,
wherein the section of the waveguide core is positioned between the grating and the dielectric layer.

18. The structure of claim 1 wherein the grating directly contacts the section of the waveguide core.

19. The structure of claim 1 further comprising:
a plurality of contacts coupled to respective portions of the grating.

20. A method of forming a structure for a photonic chip, the method comprising:
forming a grating that includes a plurality of segments, wherein the grating comprises a material having a refractive index that is variable in response to a stimulus; and
forming a waveguide core that includes a section adjacent to the plurality of segments of the grating.
